(19) United States
(12) Patent Application Publication
(10) Pub. No.: US 2009/0031943 A1
(43) Pub. Date: Feb. 5, 2009

(54) Garage stop guidance pole

(76) Inventor: Jilin Wang, Frisco, TX (US)

Correspondence Address: Jilin Wang, 7898 Greenvalley Ln, Frisco, TX, 75034, US

(21) Appl. No.: 12/079,581

(22) Filed: Mar. 27, 2008

Related U.S. Application Data
(60) Provisional application No. 60/962,581, filed on Jul. 30, 2007.
(60) Provisional application No. 60/993,199, filed on Sep. 11, 2007.

(51) Int. Cl. B60Q 1/48

(52) U.S. Cl. 116/28 R

(57) ABSTRACT

A garage stop guidance pole, including: a) a telescopic pole, b) a support spring that holds the telescopic pole, and c) a base holding the support spring and requiring no fastening to a wall or a floor. The support spring is strong enough to hold the pole straight when neither the pole nor the spring is touched by a vehicle to be guided but provides swing motion when it is bumped by the vehicle to provide indication to the vehicle driver to stop at a preferred location.

### CROSS-REFERENCE TO OTHER APPLICATION

Priority is claimed from U.S. provisional applications 60/962,581, 60/993,199, which is hereby incorporated by reference. Those applications may be related to the present application, or may merely have some drawings and/or disclosure in common.

### BACKGROUND

This invention relates generally to position indication device, more specifically to a vehicle parking guidance device which gives the driver of an automobile indication to stop the vehicle at the designated position in a garage or a parking area.

To stop a vehicle in an enclosed area such as garage at a desired position requires considerable accuracy. It is often difficult for a driver to determine when exactly the vehicle should be stopped so as to avoid the bumper of the vehicle striking the wall of the garage or to avoid the opposite end bumper being in the way of the garage door.

### DESCRIPTION OF THE PRIOR ARTS

U.S. Pat. No. 3,219,972 discloses a parking indicator assembly box which needs to be mounted on the wall of the garage.

U.S. Pat. No. 4,101,868 discloses a stop sign device. This device includes a lever and a stop indicator box which is also mounted on the wall of the garage.

U.S. Pat. No. 4,288,777 discloses a stop indicator device wherein a lever is used and its assembly is mounted on the wall of the garage as well.

All above three devices comprise too many working part, they are limited to the wall mounting position so that it loses wide range usage and loses its commercial value.

U.S. Pat. No. 3,793,981 discloses a stop indicator device which mainly includes a plumb that is suspended from an overhead support, which needs a great deal of efforts to install and it failed to adapt to the different height of the hood of other kind vehicles.

### SUMMARY

The present application discloses new approach to provide an improved parking guide device to provide indication to the driver to stop the vehicle at exact desired position in the garage or a designated parking area. The disclosed device has at least the following advantages:
It can be universally used for any type of automobile;
It is in light weight and compact size so that it is easily to be carried and installed at any desired position; and
It composed of few parts and in low cost.

These advantages of the disclosed inventions will become apparent and understood to those skilled in the art as the description thereof with the reference in the following drawings.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows the Garage stop guidance pole.

FIG. 2 shows an example of the application of the Garage stop guidance pole.

### REFERENCE NUMERALS IN DRAWINGS

10 telescope Pole
12 support spring
14 base

### DETAILED DESCRIPTION OF SAMPLE EMBODIMENTS

The numerous innovative teachings of the present application will be described with particular reference to presently preferred embodiments (by way of example, and not of limitation).

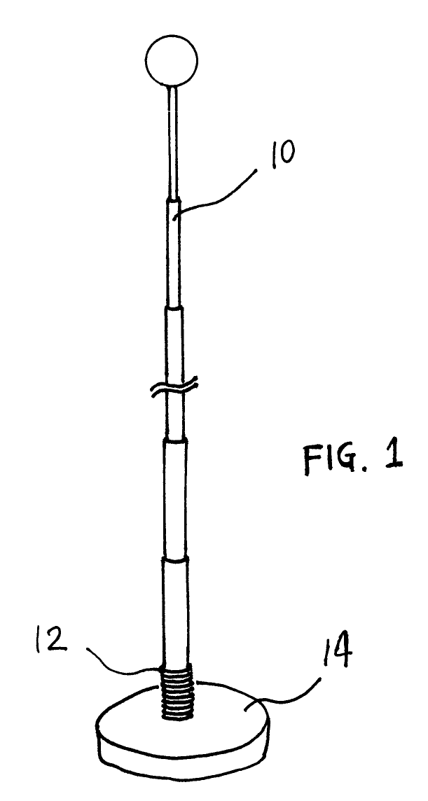

FIG. 1 shows an embodiment of the disclosed device. The telescopic pole 10 is mounted into the support spring 12. The support spring 12 not only provides support to the telescope pole 10, but also is flexible such that it allows telescopic pole 10 to swing when touched or collided by the approaching bumper of a vehicle. The support spring 12 is mounted on a base 14 which is heavy enough to hold the support spring 12 and telescopic pole 10 in place.

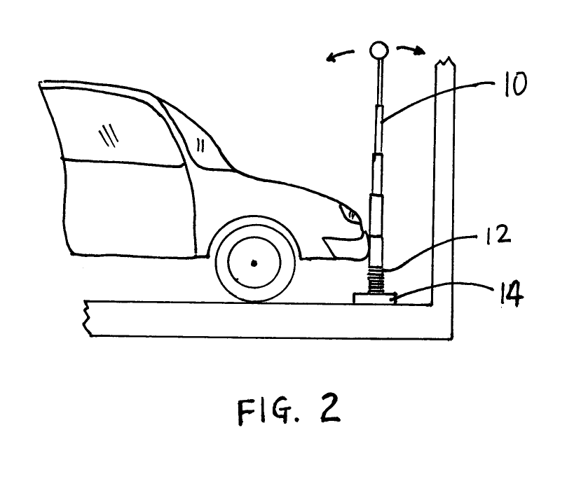

FIG. 2 shows an application of the disclosed device. The slight movement of the telescopic pole 10 caused by the touching of the approaching bumper of a vehicle provides indication to the driver to make an immediate stop at the current position.

In conclusion, this invention of the Garage stop guidance pole is easy to install by just placing it at a desired location without any nail or screw, is easy to adjust to vehicles with various sizes by simply moving the base to another location. It provides a driver a simple and dependable way to stop the vehicle at the very desired position in the garage or at a designated parking area.

According to various embodiments, there is provided a garage stop guidance pole, comprising: a) a telescopic pole, b) a support spring that holds said telescopic pole, and c) a base holding said support spring and requiring no fastening to a wall or a floor, wherein said support spring is strong enough to hold said pole straight when neither said pole nor spring is touched by a vehicle but provides swing motion when it is bumped by said vehicle to provide indication to the driver of said vehicle.

It should be obvious that there are variations and modifications to the disclosed innovations. Those variations and modifications should be obvious to those with ordinary skills in the art.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A garage stop guidance pole, comprising:
a) a telescopic pole,
b) a support spring that holds said telescopic pole, and
c) a base holding said support spring and requiring no fastening to a wall or a floor, wherein said support spring is strong enough to hold said pole straight when neither said pole nor spring is touched by a vehicle but provides swing motion when it is bumped by said vehicle to provide indication to the driver of said vehicle.

2. The garage stop guidance pole of claim 1, therein the said telescopic pole is made of metal.

3. The garage stop guidance pole of claim 1, therein the said telescopic pole is made of plastic.

4. The garage stop guidance pole of claim 1, therein the said telescopic pole is made of wood.

5. The garage stop guidance pole of claim 1, therein the said base is simply place on the floor.
